(19) United States
(12) Patent Application Publication
(10) Pub. No.: US 2007/0153719 A1
(43) Pub. Date: Jul. 5, 2007

(54) Scheduling of broadcast message transmission to increase paging capacity

(75) Inventor: Thawatt Gopal, San Diego, CA (US)

Correspondence Address: COATS & BENNETT, PLLC, 1400 Crescent Green, Suite 300, Cary, NC, 27518, US

(73) Assignee: Telefonaktiebolaget LM Ericsson (publ)

(21) Appl. No.: 11/321,612

(22) Filed: Dec. 29, 2005

(51) Int. Cl. H04Q 7/00

(52) U.S. Cl. 370/328

(57) ABSTRACT

Broadcast control messages are repetitively transmitted to said mobile stations over successive control channel cycles to meet minimum recommended periodicity requirements. To increase paging capacity, the frequency of one or more of the broadcast control messages may be varied to avoid unfavorable pairings of the broadcast control messages within a single control channel cycle.

### BACKGROUND

The present invention relates generally to transmission of broadcast control messages to mobile stations in a mobile communication network and, more particularly, to a method and apparatus for scheduling transmission of the broadcast control messages to increase paging capacity.

In many mobile communication systems, a common control channel serves both as a broadcast control channel for transmitting overhead messages and system parameters to mobile stations, and as a common channel for transmitting dedicated control messages, such as page messages, to specific mobile stations. Broadcast control messages for broadcasting Sector Parameters are typically transmitted with a minimum required periodicity. The channel capacity remaining after accounting for scheduled transmissions of broadcast control messages may be used for paging mobile stations, or for sending other dedicated control messages to specific mobile stations.

The implementation of packet data services, such as voice-over-IP (VoIP) and push-to-talk (PTT) implemented according to Rev. A of the EV-DO interface, involve more frequent paging, and therefore will require greater paging capacity than the data services implemented according to Rev. 0 of the EV-DO interface. Since paging messages share bandwidth with broadcast control messages, the number, size, and frequency of the broadcast control messages limits the remaining capacity of the control channel available for paging mobile stations. Allocating additional bandwidth to the control channel is not desirable since it reduces the bandwidth available for transmitting user data. In addition, when control channel transmissions are sent over the air, ongoing user data transmissions will need to be pre-empted. This may cause scheduling problems, particularly for VoIP, where pre-empting user data may indirectly lead to dropped VoIP data packets. Therefore, there is an interest in developing methods to increase paging capacity on the control channels without allocation of additional bandwidth.

### SUMMARY

The present invention provides a method of efficiently scheduling the transmission of broadcast control messages over a common control channel so as to increase the available bandwidth for paging and similar purposes. The broadcast control messages are transmitted to the mobile stations over successive control channel cycles so as to meet minimum recommended periodicity requirements. In some instances, the transmission of two or more particular broadcast control messages in the same control channel cycle may significantly reduce the available capacity for other purposes. Such unfavorable pairings of broadcast control messages in the same control channel cycle are avoided by varying a broadcast interval between successive transmissions of one or more selected broadcast control messages. In other words, the periodicity of selected broadcast control messages may be varied over time to avoid the unfavorable pairings of particular broadcast control messages in the same control channel cycle. The transmission of broadcast control messages may be according to a fixed schedule or a dynamically adjustable schedule that can be modified based on factors such as message size, frequency, etc.

One exemplary embodiment of the invention applies to HRPD networks. In this exemplary embodiment, the broadcast control messages include a Sector Parameters message and an Access Parameters message. Both the Sector Parameters message and the Access Parameters message are relatively large messages. Therefore, to avoid transmitting an Access Parameter message in the same control channel cycle as a System Parameter message, the broadcast interval between successive Access Parameter messages can be varied over time. As an example, the broadcast interval between successive Access Parameter messages may be reduced from three control channel cycles (the minimum requirement) to two control channel cycles to prevent the Access Parameter message from being transmitted in the same control channel cycle as the Sector Parameters message.

### BRIEF DESCRIPTION OF THE DRAWINGS

FIG. 1 illustrates an exemplary mobile communication network

FIG. 2 illustrates the functional elements of an exemplary access node in a mobile communication network.

FIG. 3 illustrates an exemplary structure of a forward traffic channel in a mobile communication.

FIG. 4 illustrates an exemplary broadcast schedule for broadcast control messages.

FIG. 5 illustrates an exemplary broadcast schedule for broadcast control messages.

FIG. 6 is a flow chart illustrating an exemplary scheduling algorithm for scheduling broadcast control messages.

FIG. 7 is a flow chart illustrating another exemplary scheduling algorithm for scheduling broadcast control messages

### DETAILED DESCRIPTION

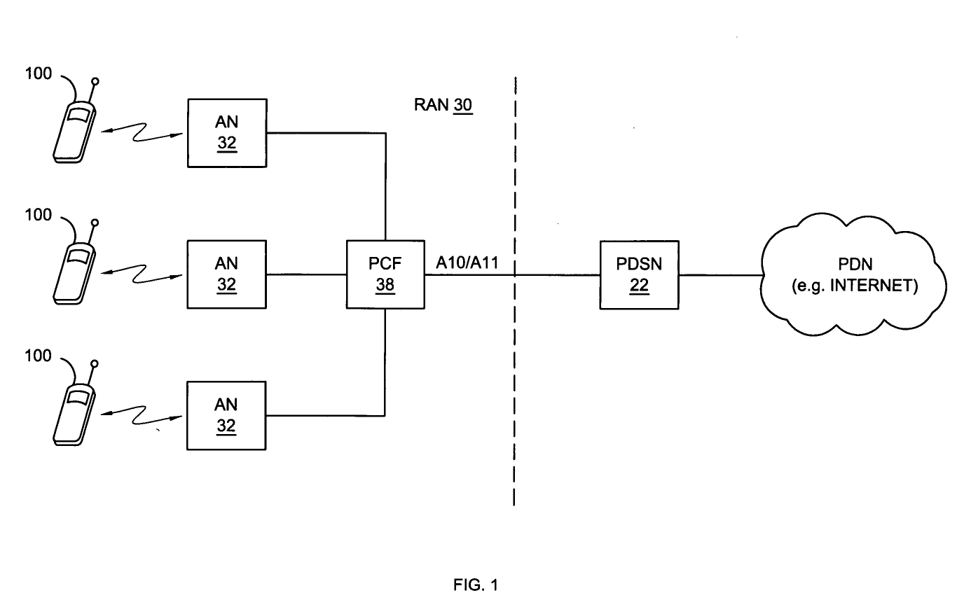

FIG. 1 illustrates an exemplary mobile communication network indicated generally by the numeral 10. The network 10 may be configured according to any known network standard including without limitation the HRPD (TIA-856A), cdma2000 (TIA-2000), Wideband CDMA, GPRS/EDGE and WiMax standards. The exemplary embodiment shown in FIG. 1 is configured according to the HRPD standard.

Mobile communication network 10 comprises a packet-switched core network 20 and one or more radio access networks (RANs) 30. The core network 20 includes a Packet Data Serving Node (PDSN) 22 for connecting to an external packet data network (PDN) 12, such as the Internet. The PDSN 22 supports PPP connections with the mobile station 100 and routes packets to and from the mobile stations 100. The RAN 30 provides the connection between the mobile stations 100 and the core network 20. The RAN 30 comprises a plurality of access networks (ANs) 32, and at least one access Packet Control Function (PCF) 38. The ANs 32, which are also known as base stations (BSs), communicate with the mobile stations 100 over the air interface. The PCF 36 establishes, maintains, and terminates connections between the RAN 30 and the PDSN 22. While shown as separate network elements in FIG. 1, those skilled in the art will appreciate that the functions of the AN 32 and PCF 38 can be integrated into a single network element.

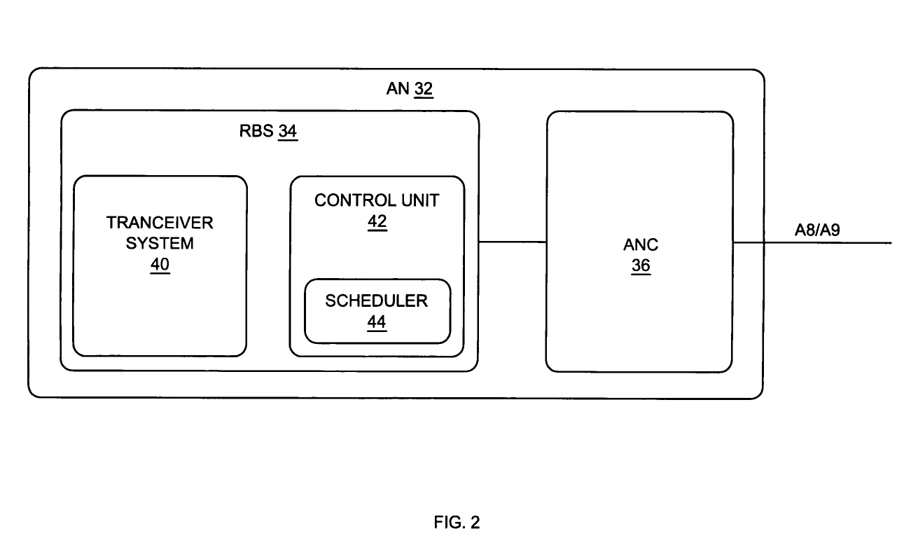

An exemplary AN 32 is shown in more detail in FIG. 2. The AN 32 includes a radio base station (RBS) 34 and access network controller (ANC) 36. The RBS 34 comprises a transceiver system 40 for communicating over the air interface with mobile stations 100. The RBS 34 further includes a control unit 42 to perform functions such as power control, data rate control, and scheduling as is well known in the art. The control unit includes a scheduler 44 for scheduling transmission of messages as will be hereinafter described. The ANC 34 manages radio resources of the AN 32 and handles Layer 3 signaling.

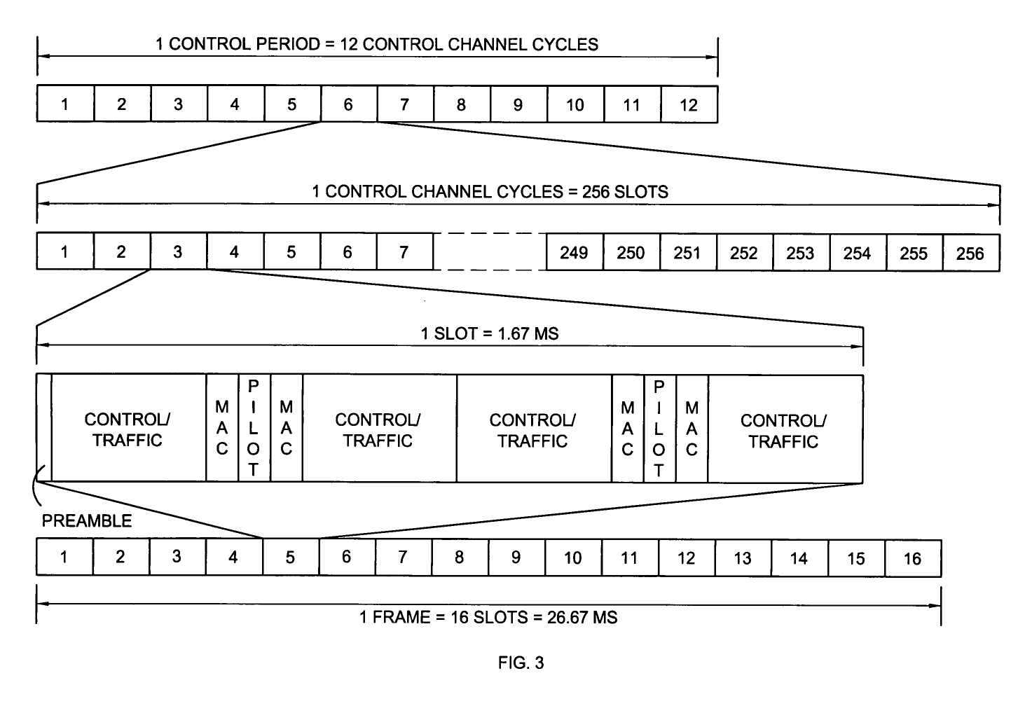

In HRPD systems, there is only one composite forward physical channel, which carries the pilot, MAC (Medium Access Control), control and traffic channels. The structure of the forward physical channel is shown in FIG. 3. The forward physical channel is divided into 26.67 ms frames, which is further divided into 16 slots of 1.67 ms duration. Each slot is further divided into half-slots containing 1024 chips. During an active slot, the pilot, MAC, control and traffic channels are time multiplexed as shown in FIG. 3 and transmitted at full power. When there are no traffic or control channels to be transmitted on the forward link, the AN 32 transmits idle slots that have the same structure, but with zero power during the traffic/control periods. The pilot channel takes 96 chips of each half-slot and the MAC channel takes 800 chip in each half-slot, leaving 800 chips for traffic and control channels.

The control channels have a 256 slot (16 frames) cycle, referred to herein as a control channel cycle. During each control channel cycle, control messages are sent to mobile stations in either synchronous, sub-synchronous, or asynchronous capsules. The remaining slots are used by the forward traffic channel. The synchronous capsule is transmitted at nominal data rates of either 38.4 kbs (8 slots) or 76.8 kbs (16 slots) at a fixed offset from the beginning of each control channel cycle. Asynchronous capsules can be transmitted at any time. The synchronous capsule may be used to transmit broadcast control messages and dedicated control messages to mobile stations. Broadcast control messages sent in the synchronous capsule include the Sector Parameters message, the Access Parameters message, the Sync message, the Quick Configuration message, and the Broadcast Reverse Rate Limit (BRRL) message. Dedicated control messages transmitted in the synchronous capsule include Page messages, Traffic Channel Assignment messages, and Access Channel Acknowledgement (AcACK) messages.

The HRPD standard (IS-856A) defines a control period comprising 12 control channel cycles for idle state operations. When the mobile station 100 is in the idle state, it sleeps and wakes-up periodically to monitor the control channel for incoming pages and other control messages. In the idle state, the mobile stations 100 monitor a particular control channel cycle in each control period for incoming pages. The control channel cycle monitored by the mobile station 100 is determined by a hashing function to uniformly distribute the mobile stations 100 across all twelve control channel cycles in a control period. Due to the hashing function, a mobile station 100 will always monitor the same control channel cycle in a control period. To page the mobile station 100, the AN 32 must send a page message in the control channel cycle that is monitored by the mobile station 100. As noted above, the page messages may be transmitted in the synchronous capsule, which is also used to transmit broadcast control messages.

The IS-856 standard specifies that the broadcast control messages be sent with certain recommended minimum periodicity requirements. Table 1 below gives the periodicity requirements for selected broadcast control messages.

TABLE 1
Recommended Frequency of Broadcast Control Messages

| | Recommended Frequency in Control |
|---|---|
| Broadcast Control Message | Channel Cycles |
| Quick Configuration | 1 |
| Access Parameters | 3 |
| Sync | 3 |
| Sector Parameters | 4 |
| Broadcast Reverse Rate Limit | Not specified |

The paging capacity using synchronous capsules is dependent on the remaining capacity of the synchronous capsule after accounting for any scheduled broadcast control messages. As used herein, the term paging capacity refers to the remaining capacity of the synchronous capsule in a given control channel cycle after accounting for any scheduled broadcast control messages. Those skilled in the art will understand; however, that the paging capacity can be used to send not only Page message, but also other dedicated control messages, such as Traffic Channel Assignment (TCA) messages and Access Channel Acknowledgement (AcACK) messages. The broadcast control messages will vary in size and frequency, so the paging capacity in the synchronous capsule will vary from one control channel cycle to the next over a broadcast control period. Because mobile stations 100 will always monitor the same control channel cycle for incoming pages, it is desirable that the minimum paging capacity across all twelve control channel cycles be above a predetermined threshold. In other words, the paging capacity for the air interface defined by IS-856 is the minimum of the leftover capacity across all twelve control channel cycles. For example, the paging capacity equals min{Leftover(CCC0), Leftover(CCC1), . . . , Leftover(CCC11)}, where Leftover(CCCi) is the leftover capacity in the i^{th} control channel cycle.

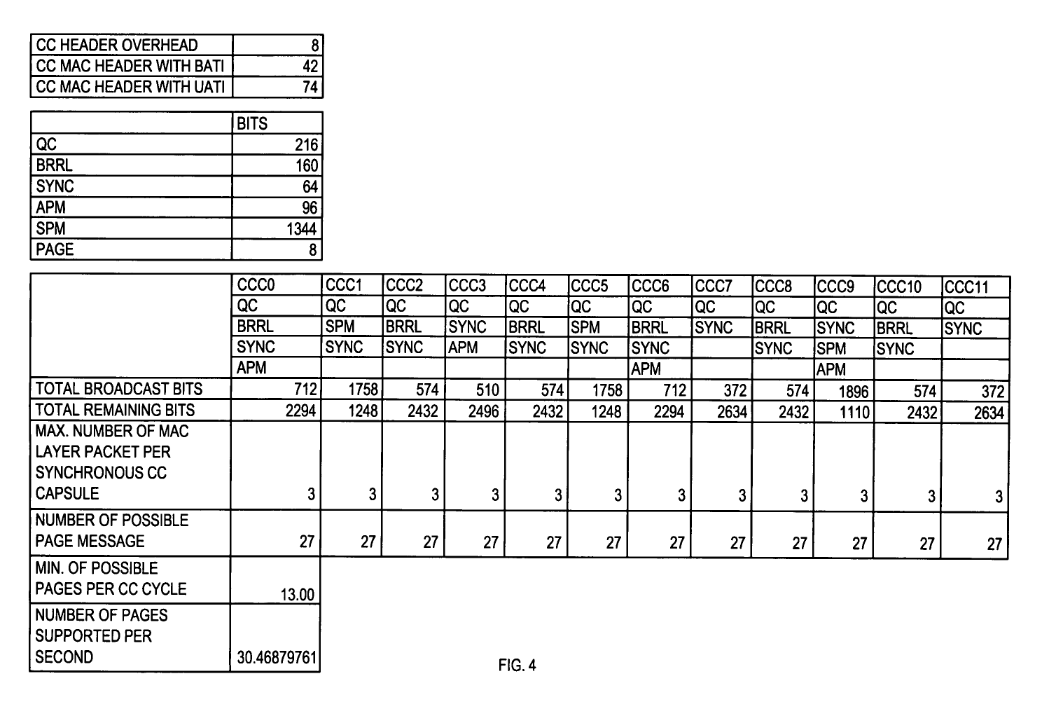

Conventionally, the broadcast control messages are transmitted according to a fixed broadcast schedule that meets the minimum periodicity requirement. FIG. 4 illustrates an exemplary broadcast schedule representing the prior art approach for transmission of broadcast channel messages. In the broadcast schedule shown in FIG. 4, the Quick Configuration (QC) and Sync (S) messages are sent in every control channel cycle (CCC0, CCC1, . . . , CCC11). The Broadcast Reverse Rate Limit (BRRL) message is sent in every even numbered cycle (CCC0, CCC2, . . . , CCC10). The Access Parameter (AP) message is sent in every third cycle beginning with the first cycle (CCC0, CCC3, CCC6, CCC9). The Sector Parameters message is sent in every fourth cycle beginning with the second cycle (CCC1, CCC5, CCC9). Because the broadcast interval for the Sector Parameters message is an integer multiple of the broadcast interval for the broadcast reverse relate limit message, these two messages never occur in the same control channel cycle. However, the Sector Parameters message and Access Parameters message do occur in the same control channel cycle (i.e., CCC9). Because the Sector Parameters message and Access Parameters message are both large messages, the combination of these two messages in the same control channel cycle results in the lowest number of pages across all twelve control channel cycles. In this example, the paging capacity assuming three MAC packets per control channel capsule is estimated to be approximately 13 pages or 30.46 pages per second in the control channel cycle denoted as CCC9. This calculation assumes that the Sector Parameters message is carrying the maximum possible number of neighbor information in the Sector Parameters message.

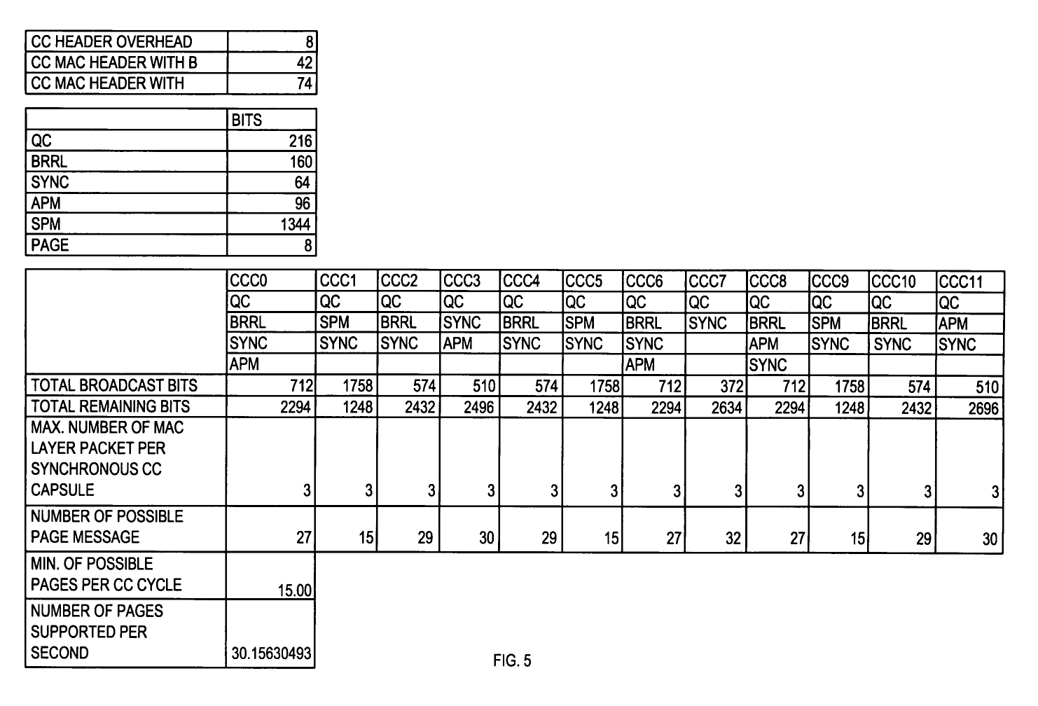

FIG. 5 shows an alternate broadcast schedule according to one exemplary embodiment of the invention that avoids the unfavorable pairing of the Sector Parameters message and Access Parameters message in the same control channel cycle. In this exemplary embodiment, the Quick Configuration and Sync messages are sent in every control channel cycle (CCC0, CCC1, . . . , CCC11). The Sector Parameters message is sent in every fourth control channel cycle beginning with the second (CCC1, CCC5, CCC9). The Access Parameters message, however, is transmitted with a variable frequency to prevent the unfavorable pairing with the Sector Parameters message. In other words, the broadcast interval of the Access Parameters message varies over time. In the exemplary embodiment shown in FIG. 5, the Access Parameters message is transmitted in control channel cycles 0, 3, 6, 8, and 11. After the third occurrence of the Access Parameters message, the broadcast interval changes from three control channel cycles to two control channel cycles to avoid transmitting the Access Parameters message in control channel cycle 9. After the fourth occurrence of the Access Parameters message, the broadcast interval switches back from two control channel cycles to three control channel cycles. By varying the broadcast interval of the Access Parameters message, the minimum number of pages across all twelve control channel cycles is increased from 13 to 15 in control channel cycle 9. By varying the broadcast interval of the Access Parameters message, the paging capacity in control channel cycle 9 is increased to 35.16 pages per second, a 15.4% increase as compared to the approach illustrated in FIG. 4.

In the embodiment shown in FIG. 5, a fixed broadcast schedule repeated in every control period (i.e. every 12 control channel cycles) is used. In other embodiments of the invention, a dynamic approach can be taken in which a control channel scheduler at the AN 32 adaptively varies the periodicity of the broadcast control messages based on constraints, such as the size of the broadcast messages and the recommended frequency of the broadcast control messages. The scheduler may implement a scheduling algorithm that predicts a paging capacity for a plurality of different hypothesized broadcast schedules to select a schedule that maximizes the paging capacity. In other embodiments, the scheduling algorithm can identify unfavorable pairings of broadcast control messages (e.g., the pairing of the Sector Parameters message and the Access Parameters message) and vary the periodicity of one of the messages to avoid the unfavorable pairing. The dynamic approach adds complexity to the scheduling of broadcast control messages, but has the advantage of increasing flexibility and optimizing paging capacity.

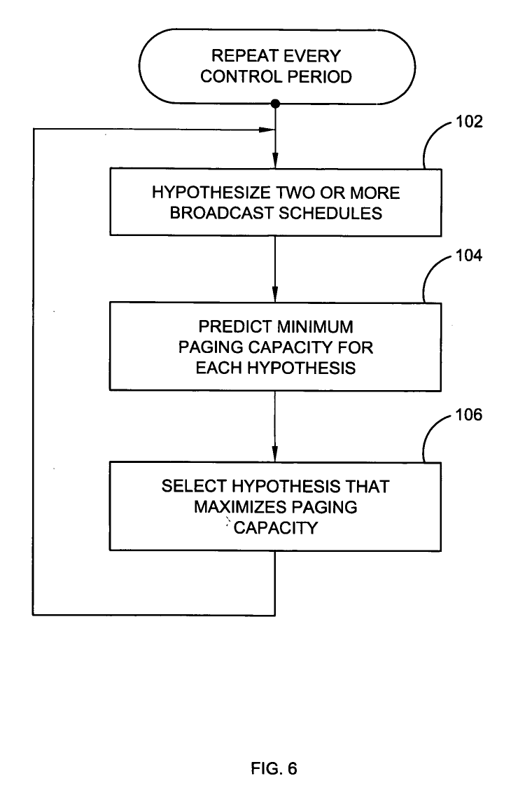

FIG. 6 illustrates one exemplary scheduling algorithm for scheduling broadcast control messages. The scheduling algorithm is implemented before the beginning of each control period. The scheduling algorithm hypothesizes two or more different broadcast schedules (block 102) and predicts the minimum paging capacity across all twelve control channel cycles for each proposed broadcast schedule (block 104). The scheduling algorithm then selects the broadcast schedule that maximizes the paging capacity (block 106) and the procedure ends (block 108).

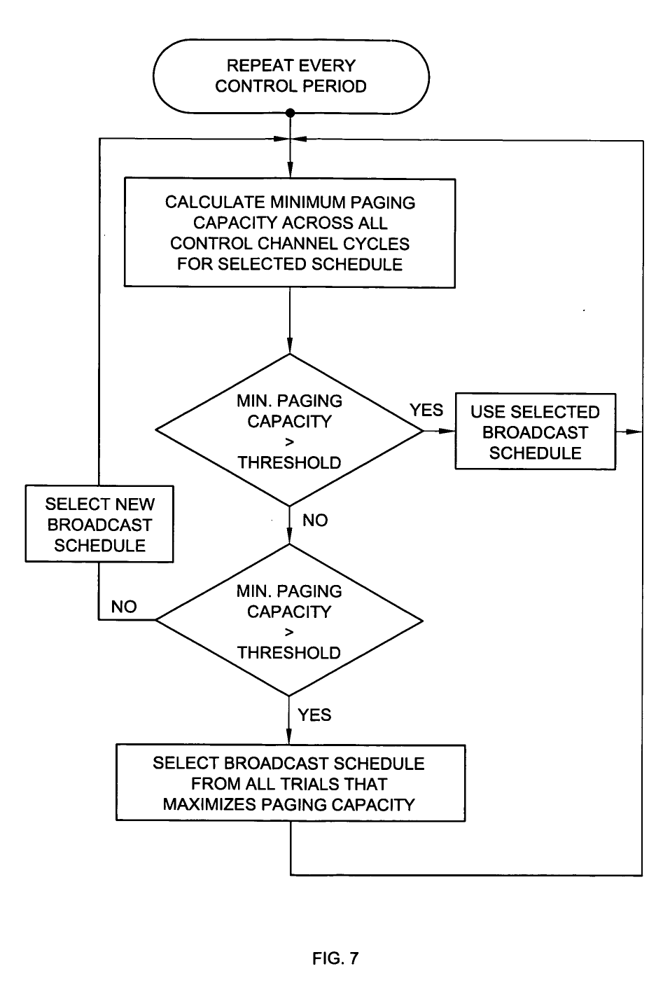

FIG. 7 illustrates another exemplary scheduling algorithm for scheduling broadcast control messages. The scheduling algorithm is executed before the beginning of each control period. The minimum paging capacity across all twelve control channel cycles is calculated for an initial proposed broadcast schedule (block 110) and compares the calculated value to a defined threshold (block 112). The initial proposed broadcast schedule may, for example, comprise the broadcast schedule used in the last control period or a default broadcast schedule. If the paging capacity for the initial proposed broadcast schedule meets a defined threshold, the initial proposed broadcast schedule is used (block 114). If, however, the minimum paging capacity does not meet the threshold, the scheduling algorithm determines if a predetermined number of trials has been performed (block 116). If not, the scheduling algorithm selects a new broadcast schedule (block 118). In this step, the scheduling algorithm may vary the periodicity of one or more broadcast control messages to generate a new broadcast schedule. If the revised broadcast schedule meets the threshold requirement, the revised broadcast schedule is used. This process may be repeated continuously until a revised broadcast schedule meeting the threshold requirement is obtained or until a predetermined number of trials has been reached. In the latter case, the broadcast schedule that maximizes the paging capacity is selected (block 120).

In the case of an AN 32 that uses a distance-based registration mechanism to keep track of mobile station location, the AN 32 needs to page the mobile station 100 in several cells to increase the probability of reaching the mobile station 100. This procedure is known as zone-based paging. The larger the number of cells in a paging zone, the larger the capacity consumed on the control channel. By optimizing the transmission of broadcast control messages as described above, the paging capacity can be increased. With a higher paging capacity, larger paging zones can be used for zone-based paging and registration frequency can thus be reduced. The reduction in registrations will also reduce the load on the forward control channel, since for every registration message (Route Update message), a corresponding AcACK message needs to be sent on the control channel to acknowledge the Route Update message. The present invention will also be important for applications such as voice-over IP and push-to-talk, which will require more frequent paging of mobile stations 100. Increasing the paging capacity of the synchronized capsule will be important to support such applications.

The present invention may, of course, be carried out in other specific ways than those herein set forth without departing from the scope and essential characteristics of the invention. The present embodiments are, therefore, to be considered in all respects as illustrative and not restrictive, and all changes coming within the meaning and equivalency range of the appended claims are intended to be embraced therein.

What is claimed is:

1. A method implemented in a mobile communication network of scheduling the transmission of broadcast control messages to mobile stations, said method comprising:
repetitively transmitting said broadcast control messages to said mobile stations over successive control channel cycles to meet minimum recommended periodicity requirements for said broadcast control messages; and
varying a broadcast interval between successive transmissions of one or more selected broadcast control messages to avoid unfavorable pairings of said broadcast control messages within a single control channel cycle.

2. The method of claim 1 wherein said broadcast control messages are transmitted according to a fixed broadcast pattern that repeats over a defined broadcast control period comprising a plurality of control channel cycles.

3. The method of claim 2 wherein said broadcast control messages are transmitted according to a broadcast pattern that is dynamically variable.

4. The method of claim 3 wherein said selected broadcast control messages for which said broadcast intervals are varied are dynamically chosen depending on message size.

5. The method of claim 1 wherein said broadcast control messages are sent over a common control channel along with unicast control messages.

6. The method of claim 5 wherein varying an interval between successive transmissions of one or more selected broadcast control messages to avoid unfavorable pairings of said broadcast control messages within a single control channel cycle comprises varying the broadcast interval for selected broadcast control messages to avoiding pairings of large messages so as to increase a remaining capacity in said control channel cycle for transmission of unicast control messages.

7. The method of claim 1 wherein said mobile communication network comprises an HRPD network.

8. The method of claim 7 wherein said set of broadcast control messages include an Access Parameters message and a Sector Parameters message.

9. The method of claim 6 wherein varying an interval between successive transmissions of one or more selected broadcast control messages to avoid unfavorable pairings of said broadcast control messages within a single control channel cycle comprises varying the broadcast interval for said Access Parameters message to avoid paring with said Sector Parameters messages in the same control channel cycle.

10. A radio base station in a mobile communication network for communicating with mobile stations, said radio base station comprising:
at least one transmitter for repetitively transmitting broadcast control messages to said mobile stations over successive control channel cycles so as to satisfy minimum periodicity requirements for said broadcast control messages; and
a control unit operatively connected to said transmitter, said control unit operative to vary a broadcast interval between successive transmissions of one or more selected broadcast control messages to avoid unfavorable pairings of said broadcast control messages within a single control channel cycle.

11. The radio base station of claim 10 wherein said broadcast control messages are transmitted according to a fixed broadcast pattern that repeats over a defined broadcast control period comprising a plurality of control channel cycles.

12. The radio base station of claim 11 wherein said broadcast control messages are transmitted according to a broadcast pattern that is dynamically variable.

13. The radio base station of claim 12 wherein said selected broadcast control messages for which said broadcast intervals are varied are dynamically chosen depending on message size.

14. The radio base station of claim 10 wherein said broadcast control messages are sent over a common control channel along with unicast control messages.

15. The radio base station of claim 14 wherein varying an interval between successive transmissions of one or more selected broadcast control messages to avoid unfavorable pairings of said broadcast control messages within a single control channel cycle comprises varying the broadcast interval for selected broadcast control messages to avoiding pairings of large messages so as to increase a remaining capacity in said control channel cycle for transmission of unicast control messages.

16. The radio base station of claim 10 wherein said mobile communication network comprises an HRPD network.

17. The radio base station of claim 16 wherein said set of broadcast control messages include an Access Parameters message and a Sector Parameters message.

18. The radio base station of claim 15 wherein varying an interval between successive transmissions of one or more selected broadcast control messages to avoid unfavorable pairings of said broadcast control messages within a single control channel cycle comprises varying the broadcast interval for said Access Parameters message to avoid paring with said Sector Parameters messages in the same control channel cycle.
